(19) United States
(12) Patent Application Publication
(10) Pub. No.: US 2011/0125972 A1
(43) Pub. Date: May 26, 2011

(54) INFORMATION RECORDING DEVICE AND INFORMATION RECORDING METHOD

(76) Inventor: Takuya Ootani, Ome-shi (JP)

(21) Appl. No.: 12/854,085

(22) Filed: Aug. 10, 2010

(30) Foreign Application Priority Data
Nov. 24, 2009 (JP) 2009-266459

(51) Int. Cl. G06F 12/08; G06F 12/00

(52) U.S. Cl. 711/136; 711/143; 711/E12.001; 711/E12.022; 711/E12.026

(57) ABSTRACT

In one embodiment, there is provided an information recording device that includes: a plurality of cache buffers on which writing is performed in response to an external write request; and a controller configured to determine, according to an LRU algorithm, which of the cache buffers writing should be performed on. If a range of the write request does not overlap with any of cache ranges of the cache buffers and if an effective range of one of the cache buffers includes the end of its cache range, the controller preferentially uses the one of the cache buffers whose effective range includes the end of its cache range, instead of a cache buffer candidate that is determined according to the LRU algorithm.

### CROSS-REFERENCE TO RELATED APPLICATION

This application claims priority from Japanese Patent Application No. 2009-266459, filed on Nov. 24, 2009, the entire contents of which are hereby incorporated by reference.

### BACKGROUND

1. Field

Embodiments described herein generally relate to an information recording device and an information recording method.

2. Description of the Related Art

Nonvolatile flash memories as typified by an SD card have a feature that an advantageous unit of data writing exists and the performance lowers if access for writing of data that is smaller than the advantageous unit is made repeatedly. In view of this, in SD host controller drivers and file systems, write caching is performed to increase the advantageous unit of data writing.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a block diagram showing the configuration of a personal computer (PC) according to a first embodiment of the present invention;

FIG. 2 is a block diagram showing detailed configurations of the PC and a memory card according to the first embodiment;

FIG. 3 illustrates an example memory space of the memory card used in the first embodiment;

FIG. 4 illustrates how to secure a usable area in the first embodiment;

FIG. 5 illustrates how to secure a usable area in a second embodiment; and

FIG. 6 illustrates a related-art technique.

### DETAILED DESCRIPTION

According to exemplary embodiments of the present invention, there is provided an information recording device that includes: a plurality of cache buffers on which writing is performed in response to an external write request; and a controller configured to determine, according to an LRU algorithm, which of the cache buffers writing should be performed on. If a range of the write request does not overlap with any of cache ranges of the cache buffers and if an effective range of one of the cache buffers includes the end of its cache range, the controller preferentially uses the one of the cache buffers whose effective range includes the end of its cache range, instead of a cache buffer candidate that is determined according to the LRU algorithm.

Exemplary embodiments of the present invention will be hereinafter described with reference to the drawings.

### Embodiment 1

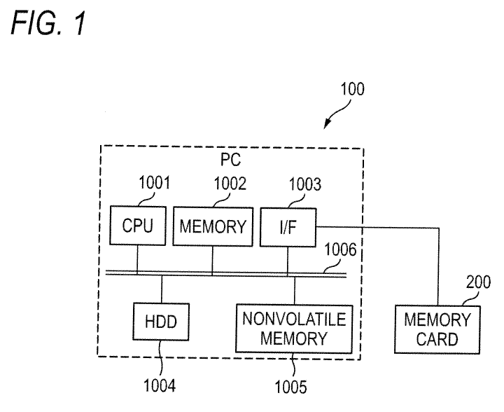

A first embodiment of the invention will be described below with reference to FIGS. 1-4 and 6.

Although the first embodiment is directed to a personal computer (PC), exemplary embodiments of the invention can be applied to file-system-incorporated apparatus which are equipped with a file system for managing data stored in an information recording medium (subject of management), such as a digital TV broadcast receiver and an optical disc recorder.

FIG. 1 shows a basic configuration of a PC 100. The PC 100 is equipped, as a main unit, with a CPU 1001 which controls individual units intensively. A nonvolatile memory 1005 such as a ROM (read-only memory) which is stored with a BIOS etc. and a memory 1002 such as a RAM for storing various data in a rewritable manner are connected to the CPU 1001 via a bus 1006.

A hard disk drive (HDD) 1004 for storing various programs such as a storage area allocation program and an interface (I/F) 1003 which is provided with a USB (universal serial bus) connector for connecting an external HDD (not shown) to the PC 100, a memory card I/F 103 into which a memory card 200 such as an SD card is to be inserted, and other things are also connected to the bus 1006 via I/O ports (not shown).

Capable of storing various data in a rewritable manner, the memory 1002 functions as a work area of the CPU 1001 and serves as a buffer etc.

An operating system (OS) and various programs are stored in the nonvolatile memory 1005. The CPU 1001 reads programs from the nonvolatile memory 1005 and installs them in the HDD 1004.

The information recording medium for storing files is not limited to the memory card 200 and may be any of various kinds of media such as any of various optical discs such as a DVD, any of various magneto-optical discs, any of various magnetic disks such as a flexible disk, and a semiconductor memory.

A program may be downloaded over a network such as the Internet via a communication control device (not shown) and installed in the HDD 1004.

Each program may be such as to operate on a prescribed OS. In this case, part of various kinds of processing may be taken over by the OS or each program may be part of program files constituting a prescribed application program, the OS, or the like.

The CPU 1001, which controls operations of the entire system, performs various kinds of processing according to programs that have been loaded in the HDD 1004 which is used as a main storage device of the system.

A program to be run by the PC 100 has a module configuration including individual sections (software 101, file system 102, and memory card interface 103; described later). That is, the CPU 1001 (processor) reads a program from the above-mentioned storage medium and runs it, whereby individual sections are loaded into the main storage device and a software 101, a file system 102, and a memory card interface 103 are generated in the main storage device.

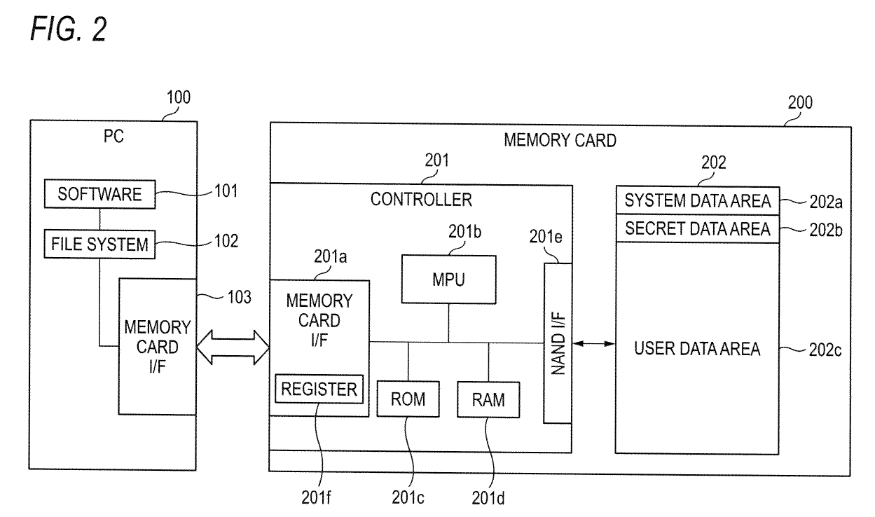

FIG. 2 outlines, in the form of functional blocks, a main part of the PC 100 and a main part of the memory card 200 (a management subject of the PC 100), which will be described in the embodiment. Each functional block can be implemented as hardware, computer software, or a combination thereof. Therefore, generally, each functional block will be described in terms of its function to clarify that it may be hardware, software, or a combination thereof.

Whether each functional block is implemented as hardware or software depends on a specific mode of implementation or design restrictions that are imposed on the entire system. A person skilled in the art can realize those functions in various methods for respective specific modes of implementation, and determining how to realize those functions is included in the invention.

As shown in FIG. 2, the PC 100 is provided with hardware and software (system) for accessing the memory card 200 that is inserted in and connected to itself. First of all, the PC 100 is provided with software 101 such as an application and an OS.

When an instruction to write data to the memory card 200, an instruction to read data from the memory card 200, or an instruction to perform other processing is made by the user, the software 101 causes the CPU 1001 to perform the processing. After executing the software 101, the CPU 1001 instructs the file system 102 to perform data writing or reading on the memory card 200.

The file system 102 is a system prepared for managing files that are stored in the information recording medium (memory card 200, management subject). The file system 102 stores management information in the storage area of the information recording medium and manages files using the management information.

More specifically, a method for generating directory information such as files and folders in the information recording medium, methods for moving and deleting a file or folder, a data storing method, locations where management information is stored and a method for using the management information, and other information are prescribed in the file system 102. The file system 102 is based on a FAT (file allocation table) file system and is configured so as to be able to perform operations that will be described below in the embodiment. Specific operations will be described below in order as appropriate.

The PC 100 is also provided with the memory card interface 103. The memory card interface 103 is formed by hardware, software, or the like that is necessary for interfacing between the PC 100 and a controller 201 of the memory card 200. The PC 100 communicates with the memory card 200 via the memory card interface 103.

Various rules that are necessary for a communication between the PC 100 and the memory card 200 are prescribed in the memory card interface 103. More specifically, the memory card interface 103 is provided with various sets of commands that the memory card interface 103 and a memory card interface 201a of the controller 201 of the memory card 200 can recognize mutually. The memory card interface 103 includes hardware details (a pin arrangement, the number of pins, etc.) that enable connection to the memory card interface 201a of the memory card 200.

When the memory card 200 is connected to the PC 100 that is a power-on state or the PC 100 is powered on in a state that the memory card 200 is connected to the PC 100, the memory card 200 starts to be supplied with power from the PC 100, performs an initializing operation, and performs necessary processing in response to access from the PC 100.

The memory card 200 is equipped with a memory 202 such as a NAND flash memory and the controller 201 for controlling the memory 202. The memory 202 stores data in a nonvolatile manner, and data writing and reading are performed on the memory 202 in units of a “page” that consists of plural memory cells. Each page is assigned a unique physical address. In the memory 202, data is erased in units of a “physical block” that consists of plural pages. There may be a case that physical addresses are assigned in units of a physical block.

The controller 201 manages a data storage state of the memory 202. The management of a data storage state means managing such information as a corresponding relationship indicating pages (or physical blocks) having what physical addresses hold data having logical addresses assigned by the PC 100, respectively, and pages (or physical blocks) having what physical addresses are in an erased state (i.e., a state that no data is stored or invalid data is stored).

The controller 201 is equipped with the memory card interface 201a, an MPU (microprocessing unit) 201b, a ROM 201c, a RAM 201d, a NAND I/F 201e, etc.

Among those components, the memory card interface 201a is hardware, software, or the like that is necessary for interfacing between the PC 100 and the controller 201. The memory card 200 communicates with the PC 100 via the memory card interface 201a.

As in the memory card interface 103 of the PC 100, various rules that are necessary for a communication between the memory card 200 and the PC 100 are prescribed in the memory card interface 201a. That is, the memory card interface 201a is provided with various sets of commands and the memory card interface 201a includes hardware details (a pin arrangement, the number of pins, etc.). The memory card interface 201a is equipped with a register 201f.

The MPU 201b supervises operations of the entire memory card 200. For example, when the memory card 200 starts to be supplied with power, the MPU 201b reads firmware (control programs) into the RAM 201d from the ROM 201c and executes the firmware.

According to the control programs, the MPU 201b generates various tables (described later) in the RAM 201d and performs prescribed processing on the memory 202 when receiving a write command, a read command, an erase command, or the like from the PC 100.

As described above, the ROM 201c is stored with the control programs etc. to be run by the MPU 201b.

The RAM 201d provides a work area for the MPU 201b and stores the control programs and various tables. The tables include a conversion table (logical-physical table) which correlates logical addresses that are assigned to data by the file system 102 of the PC 100 and physical addresses of pages where the data having those logical addresses are stored actually.

The NAND I/F 201e performs interfacing between the controller 201 and the memory 202.

The storage area of the memory 202 is divided into plural areas that correspond to respective kinds of data stored. The plural areas include a system data area 202a, a secret data area 202b, and a user data area 202c.

Among those data areas 202a-202c, the system data area 202a is an area that is secured in the memory 202 for storage of data that is necessary for operation of the controller 201. More specifically, the system data area 202a is mainly stored with management information relating to the memory card 200 such as security information of the memory card 200 and card information such as a medium ID (identification).

The secret data area 202b is an area for storage of key information to be used for coding, secret data to be used for authentication, and other information. The PC 100 is not allowed to access the secret data area 202b.

The user data area 202c is an area which the PC 100 can freely access and use. For example, user data such as AV (audio visual) content files and video data are stored in the user data area 202c. It is assumed that in the following description the term “storage area of the memory 202” means the user data area 202c.

Part of the user data area 202c is secured for the controller 201 and control data (logical-physical table) that are necessary for its operation are stored there. This part of the user data area 202c is logically formatted by the PC 100 as a separate volume and file-managed accordingly.

Next, logical formatting of the memory 202 will be described. The memory 202 is logically formatted in the following form. The logical formatting of the memory 202 is performed by the file system 102 of the PC 100.

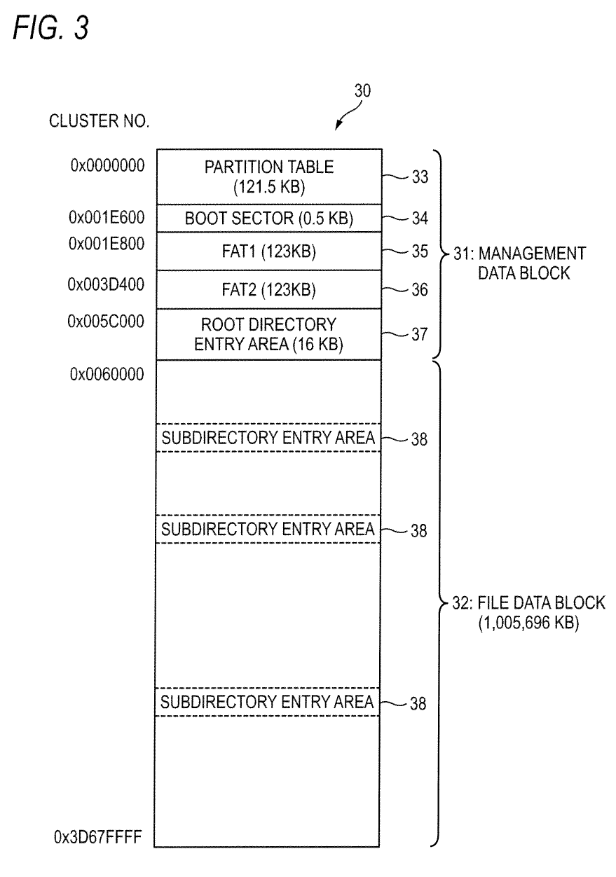

Prior to the description of the logical formatting of the memory 202 which is performed by the file system 102, a FAT file system which is the base of the file system 102 will be outlined with reference to FIG. 3.

FIG. 3 shows a memory space 30 of the memory 202 which is logically formatted by a FAT file system. The memory space 30 is stored with management data to be described below. The memory space 30 is a memory area which is freely accessible by the FAT file system, and corresponds to the user data area 202c shown in FIG. 2.

As shown in FIG. 3, the FAT file system manages the memory space 30 (subject of management) in such a manner that it is divided into clusters having a prescribed size (e.g., 16 KB). In the memory space 30, management data are assigned to an area from the smallest cluster number to a prescribed one. In the following, the area to be stored with management data will be referred to as a management data block 31.

The area that is assigned larger cluster numbers than the management data block 31 is a data storage area to be stored with plural file data constituting files. In the following, this data storage area will be referred to as a file data block 32.

The management data block 31 is divided into a partition table area 33 which is assigned to a partition table, a boot sector area 34 which is assigned to a boot sector, a FAT1 area 35 which is assigned to FAT1, a FAT2 area 36 which is assigned to FAT2, and a root directory entry area 37 which is assigned to root directory entries.

Among the above divisional areas 33-37, the partition table area 33 is stored with file system types of respective partitions, their head sectors, and other information. The boot sector area 34 is a head sector indicated by the partition table and is stored with a BPB (BIOS (basic input/output system) parameter block).

The BPB indicates various parameters of the memory 202 which are used by a file system. In the case of the FAT file system, such parameters are written when the memory 202 is logically formatted. The FAT file system recognizes the file format parameters by reading the BPB at the time of a boot.

The FAT1 area 35 is stored with information indicating in what clusters divisional file data each having the cluster size (hereinafter referred to simply as file data) are stored and information indicating how the clusters are connected to each other and used for restoration of the file data. The FAT2 area 36 is a backup area of the FAT1 area 35 and is stored with the same contents as the FAT1 area 35.

It is advantageous that the plural file data constituting one file be assigned to continuous clusters. Therefore, in the FAT file system, empty clusters are assigned to file data in order of their cluster numbers. The FAT1 and FAT2 are stored with information indicating a connection relationship between clusters in which respective file data are stored. Therefore, an original file can be restored by reading data from clusters on the basis of information stored in the FAT1 and FAT2 (hereinafter referred to simply as the FAT).

The root directory entry area 37 is stored with file entries of respective files that belong to the root directory. Each file entry includes a file name or a folder name, a file size, attributes and file update date/time information, a flag indicating a head cluster of the file, and other information. In certain versions of the FAT format (e.g., FAT16, FAT32, and exFAT (extended FAT)), a root directory entry area can be located at an arbitrary address after the FAT.

Where a certain file belongs to a subdirectory that belongs to the root directory, the number of a cluster that is assigned to entries of that subdirectory (subdirectory entries) is written in the root directory entry area 37.

Each subdirectory entry area 37 holds file entries of respective files belonging to itself. As shown in FIG. 3, data of each subdirectory entry area 37 is written to an arbitrary cluster 38 in the file data block 32 by the FAT file system. The data of each subdirectory entry area 37 is also management data and is written frequently in many cases.

A description will now be made of a method for writing data to the nonvolatile memory, which may be either the built-in nonvolatile memory 1005 or the external memory card 200, in the system of FIG. 1.

This system is provided with plural cache buffers for bundling write requests. In the following description, it is assumed that cache A and cache B (cache buffers) exist in the memory 1002. Although caches A and B need not always have the same size, it is assumed here that they have the same size of 4 MB (example value). Whereas in the above-described related-art technique if an in-between area that exists when a write request occurs for the same buffer range is used after preceding data is written back, in the embodiment as described later in-between data is read and connected to a preceding write request.

As shown in FIG. 6, assume a case of writing plural files in a system using a general LRU (least recently used) algorithm. The LRU algorithm is an algorithm that is generally used for managing memory caches and is considered to attain highest cache utilization efficiency. An actual LRU algorithm is implemented by, for example, a method of incrementing a counter every time data is used and discarding data having small counts.

FIG. 6 shows a situation that data was written to the range of cache B after data writing to the range of cache A and a new write request has arrived. In this case, there is a problem that cache A is made a write-back candidate because cache A was used earlier than cache B.

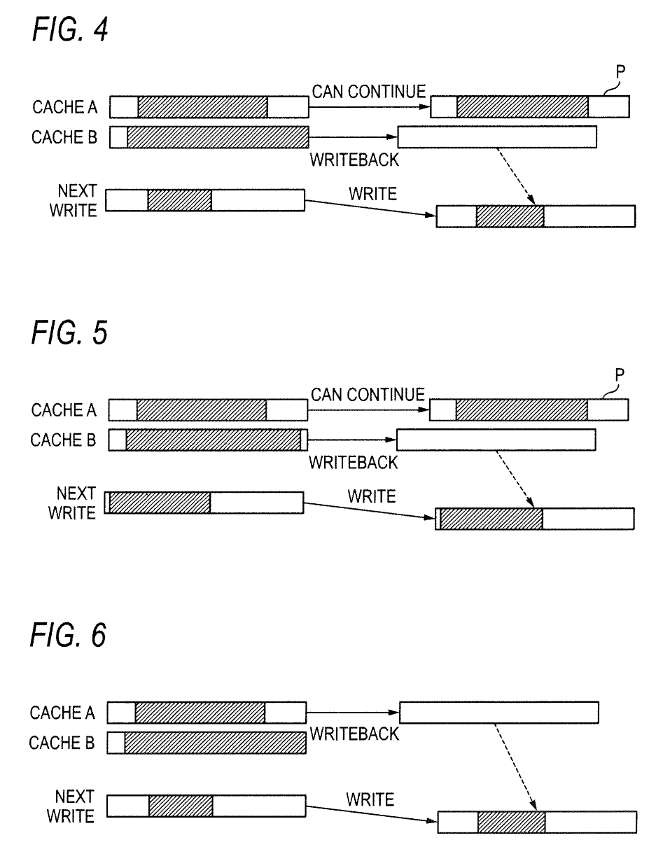

In view of the above, in the embodiment, as shown in FIG. 4, probabilities that caches A and B will be used again are taken into consideration. The data is written to cache B to its end. Since writing is performed backward in general, the probability that cache B will be used again is lower than the probability that cache A will be used again. Therefore, the cache hit ratio is increased by writing back cache B preferentially.

An operation of reading in-between data is as follows. When cache A is used again, as shown in FIG. 4 the portion before a reuse portion P is read and subjected to writing together with the reuse portion P.

### Embodiment 2

A second embodiment of the invention will be described below with reference to FIGS. 1-3 and 5. What are common to the first and second embodiments will not be described again.

In the second embodiment, an operation that is based on the LRU algorithm is performed in the same manner as in the first embodiment also in a case that data has been written to cache B almost to its end and the head of the next write request range is close to the end of cache B. This operation is employed because it is highly probable that writing to cache B caused a seek of a neighborhood of its end.

One method for judging whether data has been written to a cache buffer almost to its end is to judge whether the remaining portion of the cache buffer is smaller than a particular percentage or a particular number of kilobytes. It is advantageous to determine such a prescribed reference value using statistical information such as a use size of a program that uses the cache buffers or to vary it dynamically. Alternatively, an algorithm may be provided which determines which cache buffer to use by comparing the sizes of remaining portions of cache B and the other cache (cache A) comprehensively.

Where the number of cache buffers is limited, performing write back randomly every time a cache miss occurs results in a problem of reduction in cache hit ratio. In view of this, first, the cache hit ratio is increased by bundling write requests for portions that are close to each other. Furthermore, the cache hit ratio is increased by performing write back according to the following rules in the event of a cache miss:

(1) If the range of a write request overlaps with a certain cache range, that cache buffer is used. (In this case, no write back is performed and reading is performed on an area between an effective range in the cache buffer and the write request range.)

(2) If the range of a write request does not overlap with any cache range, a least used cache buffer is used. (Items (1) and (2) conform to the standard LRU algorithm.)

(2a) However, the effective range of a cache buffer includes the end of the cache range, this cache buffer is used preferentially.

(2b) Even if the effective range of a cache buffer does not include the end of the cache range, this cache buffer is used preferentially if the end of the cache range is close to the head of a write request range.

According to the above embodiments, the hit ratio of write data caches is increased and the performance of writing to an SD card is enhanced.

The invention is not limited to the above embodiments and various modifications are possible without departing from the spirit and scope of the invention. For example, although the embodiments are directed to the case that there are only two caches A and B, a similar approach is possible also in a case that there are three or more cache buffers.

While certain embodiments have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the sprit of the invention. The accompanying claims and their equivalents are intended to cover such forms or modifications as would fall within the scope and sprit of the invention.

What is claimed is:

1. An information recording device comprising:
a plurality of cache buffers on which writing is performed in response to an external write request; and
a controller configured to determine, according to an LRU algorithm, which of the cache buffers writing should be performed on in such a manner that if a range of the write request does not overlap with any of cache ranges of the cache buffers and if an effective range of one of the cache buffers includes the end of its cache range, the controller preferentially uses the one of the cache buffers whose effective range includes the end of its cache range, instead of a cache buffer candidate that is determined according to the LRU algorithm.

2. An information recording device comprising:
a plurality of cache buffers on which writing is performed in response to an external write request; and
a controller configured to determine, according to an LRU algorithm, which of the cache buffers writing should be performed on in such a manner that if a range of the write request does not overlap with any of cache ranges of the cache buffers and if the end of an effective range of one of the cache buffers is close to the end of its cache range, the controller preferentially uses the one of the cache buffers the end of whose effective range is close to the end of its cache range, instead of a cache buffer candidate that is determined according to the LRU algorithm.

3. The device according to claim 1, wherein if the range of the write request overlaps with one of the cache buffers, the controller does not perform write back and reads an area between an effective range of the one of the cache buffers and the write request range.

4. The device according to claim 2, wherein if the range of the write request overlaps with one of the cache buffers, the controller does not perform write back and reads an area between an effective range of the one of the cache buffers and the write request range.

5. An information recording method in which writing is performed on a plurality of cache buffers in response to an external write request, the method comprising:
(a) determining which of the cache buffers writing should be performed on, according to an LRU algorithm, the step (a) comprising:
if a range of the write request does not overlap with any of cache ranges of the cache buffers and if an effective range of one of the cache buffers includes the end of its cache range or a neighborhood thereof, preferentially using the one of the cache buffers whose effective range includes the end of its cache range or the neighborhood thereof, instead of a cache buffer candidate that is determined according to the LRU algorithm.
